(19) United States
(12) Patent Application Publication
(10) Pub. No.: US 2017/0265657 A1
(43) Pub. Date: Sep. 21, 2017

(54) MOVABLE PRESENTATION SYSTEM AND EXHIBITION METHOD

(71) Applicant: Christel Kurig, Illerrieden (DE)

(72) Inventor: Christel Kurig, Illerrieden (DE)

(21) Appl. No.: 15/317,455

(22) PCT Filed: Jun. 2, 2015
(86) PCT No.: PCT/IB2015/054168

§ 371 Date: May 12, 2017

(30) Foreign Application Priority Data
Jun. 5, 2014 (DE) 102014007990.2

(51) Int. Cl. A47F 10/00; E04H 1/12; B65G 17/06; A47F 5/10

(52) U.S. Cl. CPC A47F 10/00; A47F 5/108; E04H 1/1272; B65G 17/066; B65G 2201/02

(57) ABSTRACT

For trade fair visitors, the trade fair visit should be possible in such a way as to produce less stress and use up less energy. There is therefore a need for a presentation system with which it is possible to spare the trade fair visitor (the future customer) unnecessary walking, so the trade fair visit can become a pleasantly relaxed experience. This is achieved by an exhibition or presentation at a trade fair, in which a plurality of presentation platforms (3) are coupled to one another in the manner of a train, and the coupled presentation platforms are moved at a speed of less than 5 km/h in a continuous loop on a predetermined transport path (2) and in a predetermined direction, with this taking place past stationary areas or regions (5) for visitors to the trade fair, on which they may firstly be “stationary”, without missing out on any trade fair stand.

### FIELD OF THE INVENTION

This disclosure (and claims) relate to a movable presentation system. The invention therefore relates to a system, in particular a modular system, with which inter alia goods, exhibits or services can be presented to interested visitors in closed spaces or in the open air. The system comprises at least one stationary area or region for the visitors and at least one transport system with a plurality of presentation platforms, the presentation platforms passing the stationary area one after the other. In this case, the presentation platform may be a trade fair stand manned by staff, onto which the visitor climbs for a consultation or a negotiation and travels along together with the staff on the presentation platform. As an alternative, the presentation platform is a goods shelf and the visitor can select and remove or order individual goods from the shelf. Exhibition items of every type, for example pictures, sculptures and other exhibits, may also be arranged on the at least one platform and be guided with the at least one platform to the at least one stationary area and along it.

### BACKGROUND OF THE INVENTION

The displacement of retail food outlets into rural areas and out of the town centres is increasingly becoming a problem for people without a car, in particular for older people. Attempts to counteract this by a telephone ordering service of individual chain stores have hitherto not been particularly successful. Attempts to drive these people to the shops using free buses at the cost of the shop owners have mostly been abandoned again after a short period as this was not possible while covering costs. In addition, it was too much for the often older people to go through the generally very extensive supermarket to find and buy the required products within the timeframe predetermined by the bus departure time.

Trade fair visits to specialist trade fairs frequently become exhausting enterprises for the visitors as the trade fair visit frequently requires relatively long distances to be covered between the trade fair stands of the producers and/or service providers selected for a visit. The temperatures in the trade fair halls are generally unpleasantly high because of the numerous light fixtures and the crowds of people moving through the halls, which leads to rapid tiring and/or an irritated mood of the trade fair visitors.

The same applies to exhibition visits, in which long, predetermined distances often have to be covered to see all the exhibits. Over the duration of the exhibition visit, this generally automatically leads to the exhibits that form the end of the exhibition being paid less attention than the exhibits at the beginning. For potential customers of the retail trade and for exhibition and/or trade fair visitors, it would be advantageous if the shopping or the exhibition or trade fair visit were possible in a manner producing less stress and requiring less energy. In other words, there is a need for a presentation system with which it is possible to spare the customer or trade fair visitor unnecessary walking, so the shopping, the exhibition visit or trade fair visit becomes a pleasant relaxed experience. Exhibitions may, for example, be designed in a completely new manner by the system. Thus, art exhibitions can be utilised in the evenings as an event dinner location or the exhibition may become part of a concert or another performance, in which the exhibits are incorporated in the concert or the performance.

### SUMMARY OF THE INVENTION

This object is achieved by the system according to each of the independent claims. Advantageous are covered by each dependent claim. These may be combined with one another in a technologically reasonable manner.

The invention relates to a system to present goods or services to interested visitors comprising:
at least one stationary area or region for the visitors,
a transport system with a plurality of movable presentation platforms, which together form a transport device, wherein the presentation platforms pass the stationary area one after the other,
wherein the presentation platform is a trade fair stand manned by staff, onto which the visitor climbs for a consultation or a negotiation and travels along together with the staff on the presentation platform, and/or
the presentation platform is a goods shelf and the visitor can select and remove or order individual goods from the shelf, and/or
the presentation platform carries at least one exhibition object.

In other words, the invention relates to a modular supermarket, to a modular exhibition or to a modular trade fair, in which the customer or exhibition or trade fair visitor no longer has to go to the goods, exhibits or trade fair stands, but the goods, exhibits or trade fair stands are arranged on presentation platforms, which are moved at least in part or substantially to the customer or exhibition or trade fair visitor by a transport system. Any salesroom for any type of goods is subsumed here under “supermarket”, for example including book shops, clothing markets, food markets etc.

The customer, who may also stand by way of example as the exhibition or trade fair visitor below, stays in a stationary area or region here, for example a managed zone or an open space, to which the transport system moves the presentation platforms. The presentation platforms may be moved slowly past the stationary area by the transport system, preferably at a speed of less than a walking speed of about 5 km/h, or, in particular in the case of filled goods shelves or exhibits of an exhibition, can stop for a predetermined time in the region of the stationary area.

In other words, the transport system can move the presentation platforms continuously or clocked as desired. In this case, the transport device may form a continuous loop, in other words, the transport device has no beginning and no end. As an alternative, but less preferred, the movement direction of the transport device may be reversed if the transport device, for example, has no mutually connected ends.

The stationary area may comprise at least one large video wall, on which the presentation platform that has just moved to the stationary area or has stopped in the region of the stationary area is shown. The stationary area may also have non-moving shelves or exhibits or trade fair stands that are present in addition to the moving presentation platforms to advertise particular goods (for example special offers in a limited number, special items, etc.), or to be able to present individual exhibits to the visitor permanently, in other words during his entire stay in the stationary area.

The stationary area may comprise electronic service stations for preferably each of the visitors, with which the visitor can communicate with each of the presentation platforms, for example order an article from the shelf, retrieve information about an exhibit as spoken text or as a written and/or graphic display or can arrange an appointment with the staff of the trade fair stand.

The stationary area may have a region, in which people can climb onto a presentation platform, in particular a trade fair stand. If a person stays in this region, the speed of the transport device may be reduced again for him to climb on in order to allow him to board safely. The person staying in this region may, for example, be detected by sensors, which may be part of a safety device of the system. The sensors may be weight sensors or sensors monitoring the space, for example light barriers, cameras or infrared sensors.

In particular when the system is used at a trade fair or exhibition, the system may have more than one stationary area and more than one transport system, it being possible for the stationary areas to be arranged on only one side or on both sides of a transport track formed by the transport device and the presentation platforms. In this case, the stationary area may also be formed by the presentation platforms, while the “stationary” area described hitherto are now the transport devices that transport the visitors to the presentation platforms in this configuration.

In particular in systems with a plurality of separate stationary areas and a plurality of transport systems, the stationary areas may be connected by means of belt conveyors or transport belts, such as are known, for example, in airports to change between terminals.

These belt conveyors may, in particular in exhibitions and auctions, also be moved in portions parallel to the presentation platforms in the same direction and at the same speed in order to enable the visitor to observe certain exhibits for longer. In addition, prominent exhibits in exhibitions may be arranged permanently in the stationary area.

To be able to reach a stationary area surrounded by the transport device, visitors or customers can be guided into the stationary area by means of staircases, escalators, sloping surfaces or lifts from below or above. If this is not possible, bridges can be constructed, over which the visitors or customers can cross the transport track. Alternatively, traffic light solutions are also conceivable and this would, however, only allow access in each case at specific times and for a specific time, which is conceivable in the case of the supermarket and the exhibition/auction, but certainly does not appear practical at trade fairs. The traffic light solution could be such that the transport system is stopped for a certain time, during which the customers or visitors can cross the transport track without danger. The expression “traffic light solution” in this case comprises barriers, the opening of closed doors for a certain time and other solutions of this type.

The transport system may, for example, comprise a rail, along which the presentation platforms are drawn by means of a chain, to which they can be coupled. The track may also be part of a magnetic levitation system, on which the presentation platforms are contactlessly moved during movement. The rail may also only form a guide for the presentation platforms and one, a plurality of, or all the presentation platforms has/have a drive element, for example an electric motor, with which they can move along the rail. In this case, the drive may, for example, drive a gear wheel, which couples to the rail, or a gear rack of the rail, in order to move the presentation platform along the rail. The presentation platform(s) may be pivotably connected, in particular about an axis perpendicular to the rail, to the drive or a coupling member for coupling to the rail to allow a journey of the rigid presentation platforms along a curve of the rail track. In other words, for example, the presentation platform may be connected to a drive or guide element in such a way that while travelling round a curve, a straight line through a centre point of a circle with the curve radius centrally intersects, at all times at a right angle, a further straight line, which forms a front side of the presentation platform facing the stationary area.

Also possible are a movement of the presentation platforms along magnetic loops let into the floor, and towing along a rail, for example by a trolley that runs in a rail on the ceiling of the building. Finally, the presentation platform may also be connected to a guide device formed on a side wall of the stationary area. A combination of a plurality of couplings of the presentation platform mentioned and others that are well known to a person skilled in the art but not specially mentioned here, with a guide and/or transport system are also within the scope of the invention.

The presentation platforms may be connected to one another in such a way that a spacing between two consecutive presentation platforms does not, or virtually not, change when the transport device stops. This avoids one platform colliding with another, which, in particular in the case of trade fair stands with staff, could lead to injuries to people.

The transport system is, in particular, configured in such a way that it ensures a substantially jolt-free starting and substantially jolt-free stopping of the presentation platforms, at least in normal operation. Because of the low speed of less than 5 km/h, preferably less than 3 km/h, no mass accelerations that are dangerous to people and material are produced even in the event of an emergency stop.

If the presentation platform approaches the, or one of, the stationary areas and a person would like to leave the presentation platform there, a signal can be sent by the staff on the presentation platform to the safety device, which then, as already described in the case of the stationary area, reduces the speed of the transport device for leaving the presentation platform.

The presentation platforms may be platforms with predetermined dimensions, for example platforms with an axial length in the movement direction of the transport device of 4 m to 10 m, preferably 8 m, and a width of 2 m to 6 m, preferably 4 m. If necessary, two or more platforms can also thus be rigidly connected to one another to form a larger presentation platform. The maximum practical length of a presentation platform is predetermined by the routing of the transport track, in particular by a curve with the narrowest radius of the transport track.

A minimum spacing between two directly consecutive presentation platforms is determined by the pivoting of the presentation platforms during a journey through a curve. The spacing in particular has to be large enough for the directly consecutive presentation platforms to not touch in any position when travelling through the curve with the smallest radius. The spacing between two directly consecutive presentation platforms may be bridged here by a resiliently deformable cover, for example using the accordion principle, or a plate that can be pivoted into or below the respective presentation platform, to avoid the possibility of people being clamped between two consecutive presentation platforms. The entering of the intermediate space between two directly consecutive platforms, which should basically be prohibited when the transport device is moving, can also be monitored by corresponding detectors, for example light barriers, which are connected to the safety device of the system, which brings about an immediate emergency shutdown of the transport system when an obstacle is detected between two consecutive platforms. The presentation platforms may also be shielded, at least on the side facing the stationary area, in such a way that there is no danger of a visitor being able to reach, for example with his foot, below the presentation platform.

As already mentioned, the stationary area may be a preferably manned communication region, in which the visitors can stay. The closed spaces may be one or more connected trade fair or exhibition halls or a supermarket. Basically, the system can also advantageously be used in the open air, as all the elements of the system, like the entire transport system, can be configured to be modular and mobile, so the system can be constructed anywhere regardless of the local circumstances. In other words, when constructed in the open air, watercourses may, for example, be crossed by bridges. Finally, the system can also transport the platforms out of the closed space into the open air and vice versa, in particular when the platforms move the visitors.

In the case of a supermarket, apparatuses with electronic screens, in particular touchscreens, by means of which the goods presented on the shelves can be ordered, can be kept in readiness for the visitors. These apparatuses are given to the visitor, for example at the entrance. The visitor can then state an amount, which is the maximum he would like to spend, and this amount can then be input into the apparatus by the issuing staff and stored there.

If a goods shelf now arrives at the stationary area, all the goods presented on the shelf can additionally be shown altogether or individually one after another on a widescreen. By touching the screen once or repeatedly, the visitor can now place his order in the desired amount. In this case, it can be displayed in real time on the screen how much of the money provided for shopping is still available. It is obvious that the buyer can review his decision, delete products ordered or can retrospectively add products and/or change the predetermined sum up or down or have it changed by the staff.

The products ordered can then be placed together in a store nearby, and the customers can then receive the ordered products, already packed, for payment at the cash desk, which may, for example, be placed at the exit of the stationary area or region. On request, goods can also be carried to the vehicle or sent home.

The customer may alternatively also take the goods directly from the shelf on the presentation platform and place them in a shopping basket. In addition, goods can be placed on pallets on the presentation platform in order to be able to quickly replace the goods removed from the shelf.

In particular in the system for the supermarket, the presentation platform may alternatively be directly formed by the shelf and the shelf is therefore not arranged on an additional or separate presentation platform. In the case of direct removal by the customer, the shelves are filled like shelves in a “normal” supermarket, in other words, there are always a plurality of units of the individual products available on the shelf. If a product has run out on the shelf, the customer can wait until the same refilled shelf or a different shelf, which also has these goods, arrives at the stationary area or region again. However, the customer can also order the article that was out of stock in the shelf by means of the electronic ordering system.

The customer can then receive the electronically ordered products at the cash desk, which is arranged, for example at an exit of the stationary area or region or at the shop exit, and pay for them together with the goods located in the shopping cart. Alternatively, the customer can pay for the purchased goods directly on the spot with his debit or credit card or, where possible, for example with his mobile telephone and payment software stored thereon or connected thereto.

It is also possible for remaining stock or special offers, which are sold off directly from the presentation platform, to be presented on at least one of the presentation platforms. A change between presentation platforms with shelves for electronic ordering and the one or other presentation platform with a special event (cooking demonstration, direct sale, entertainment interlude, etc.) can positively influence the attention of the customers and, above all, encourage them to return.

The method is likewise provided for the solution to the problem.

For an exhibition or a trade fair, there is provided a stationary area or region having electronic apparatuses of the above-described type may be present where the visitor can establish which supplier is presenting on which presentation platform and at what time a certain presentation platform reaches the stationary area. He can preferably also establish contact by means of the apparatus with each of the presentation platforms to clarify whether or when he can climb from the stationary area onto the presentation platform, which questions he has for which product, or arrange an appointment for a consultation, etc.

When the system is used at a trade fair that extends over a plurality of trade fair halls and optionally an open air region, one or, a plurality of, or all the halls, and the open air region may be equipped with a system of this type. In other words, a separate system may be present in a plurality of halls or in each hall and the open air region, the separate systems not being connected to one another. Alternatively, a plurality of, or all the trade fair halls and the open air region may have a common system, so the transport device moves the presentation platform(s) or the visitors through the plurality of, or all the trade fair halls and the optional open air region.

The movement of the presentation platforms may also be possible across several storeys, for example in that the presentation platforms are transported from one storey to the next storey by means of a paternoster lift comprised by the transport device or along a sloping plane with a small gradient angle.

The transport device may, in particular, be a closed continuous transport device. The presentation platforms may preferably be coupled individually into the transport system or the transport device and decoupled individually. This coupling and decoupling may be possible when the transport system is at a standstill and it is preferably also possible when the transport device is moving. For coupling and decoupling, the running speed of the transport system can preferably be automatically reduced here by means of the safety device and the transport system can immediately be stopped by the safety device by, for example, an emergency stop, if the coupling process fails.

The system may furthermore comprise at least one service station, in which consumables or goods are disposed of from the presentation platforms and replenished, automatically or by hand. For example, the stocks of coffee, drinking water, other drinks and snacks can be renewed or replenished in the service station, used crockery can be replaced by washed crockery and packaging material can be disposed of. Stocks of consumables, for example advertising material, can be replenished. When a hired hostess is responsible for serving the guests, she can hand over the duty to a successor at the end of the shift.

Furthermore, the system may comprise one or more parking positions for at least one presentation platform in each case, in particular a trade fair stand.

The parking position is preferably arranged within or outside the continuous transport device and, to reach the parking position, the presentation platform is decoupled from the transport device and coupled to a parking position transport device. The parking position may, for example, be close to a toilet. Further parking positions may be provided so that relatively long customer conversations and/or negotiations can be carried out undisturbed. At least one of the parking positions may, for example, be in the form of a soundproof cabin in order to be able to carry out sensitive contract negotiations. Another parking position may be formed directly at a catering station in order to be able to invite special customers to dinner. A parking position may form a type of smoking cabin in order to be able to grant customers or employees who smoke a smoking break despite the existing legal situation.

So as not to have to remove all sensitive items from the presentation platform in the evenings in the case of trade fairs lasting several days, lockable parking positions can be set up, in which the presentation platform can be safely stored overnight. These parking positions may, for example, have “lids” or “hoods” that can be lowered from the ceiling for the presentation platforms, in which the means for lowering and raising the “lid” may be lockable. These parking positions may be directly connected to the safety device so an attempt by unauthorised individuals to intrude into this parking position can be discovered and an alarm triggered.

The system is preferably controlled by a central controller for the entire system or a controller each for subsystems that are not coupled to one another. This/these controller(s) controls or control the transport device, in that it, for example, regulates a clocking of the movement of the transport device and/or the speed of the transport device and controls the coupling and decoupling of individual presentation platforms in and out of the parking positions in such a way that no conflict occurs with other presentation platforms. The controller can receive signals from mobile signal transmitters, which can be operated by the crew of the presentation platforms and other staff or safety staff, causing the controller to change the speed of the transport device for climbing on and leaving the presentation platform or to abruptly stop the transport device in the case of a hazard.

The controller also receives signals from a safety device, which, for example, by means of optical sensors, monitors a safety region in a danger zone in the immediate surroundings of the presentation platforms. If a disturbance is detected in the danger zone, for example a person entering this zone, an emergency shutdown of the transport device is brought about. This emergency shutdown may preferably only be switched off when an authorised person has checked the danger zone and determined that safety has been re-established.

The safety device can also detect disturbances at individual drives or presentation platforms, such as overheating or the development of smoke, which also leads to an immediate stoppage of the transport device and the alerting of the staff responsible, such as, for example, engineers and/or the fire service.

### BRIEF DESCRIPTION OF THE DRAWINGS

Embodiments of the system will be described in more detail below with the aid of drawings, the invention not being limited to the embodiments shown. Technical features that are essential to the invention and can only be inferred from the drawings are within the scope of the invention and can advantageously develop the invention alone or in the combination shown.

It applies to the entire description and the claims that the expression “a” is used as an indefinite article and does not limit the number of parts to a single one. If “a” is to have the meaning of “only one”, this is to be understood by a person skilled in the art from the context and is clearly disclosed by the use of suitable expressions such as, for example, “a single”.

The drawings in detail show examples of the claimed invention(s). In the drawings:

FIG. 1 shows two circulating closed systems in a hall,

FIG. 2 is a perspective view of the system of FIG. 1,

FIG. 3 shows a U-shaped closed system,

FIG. 4 is a view from above of a closed system in a hall with a bridge,

FIG. 5 shows a bridge over the moving presentation platforms of FIG. 4,

FIG. 6 shows presentation platforms as goods shelves, with replacement goods on pallets.

### DETAILED DESCRIPTION OF THE INVENTION

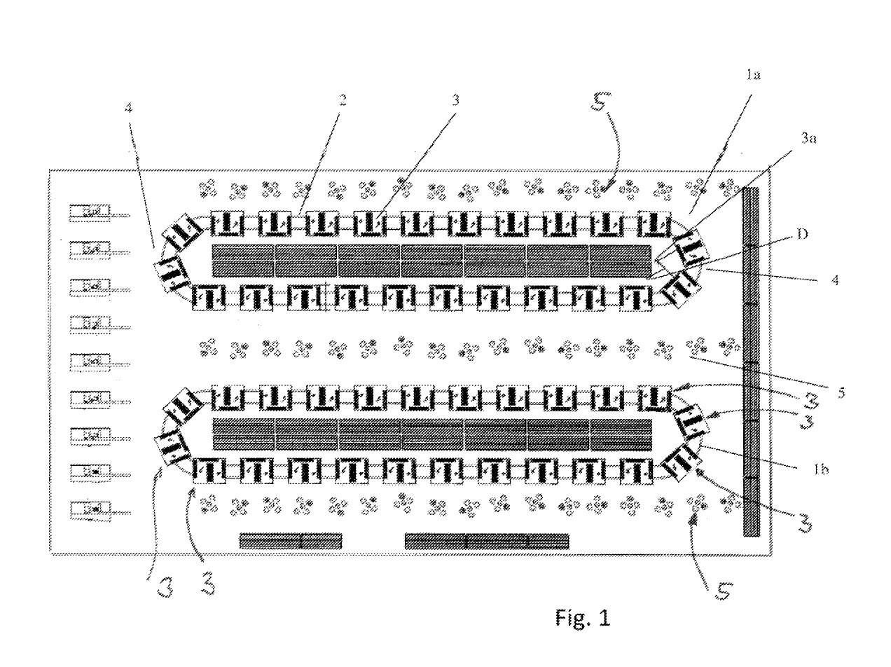

FIG. 1 shows a view from above into a trade fair hall with two separate subsystems 1a, 1b of a movable goods, exhibit and service presentation system according to the invention. As the two separate subsystems 1a, 1b are substantially identically constructed, only the subsystem 1a is described in detail below for FIG. 1. This description also applies—mutatis mutandis—accordingly to the subsystem 1b. In the embodiment shown, this may, for example, be a trade fair hall, an exhibition space or the salesroom of a market for food or a bookshop.

The subsystem 1a comprises a transport system 2, which is formed as a rail mounted on or in the hall floor. This rail may be mounted especially for a trade fair, an exhibition or another event and only remain in the hall for as long as the corresponding event lasts. In other words, once the transport system 2 has been dismantled, the hall can be otherwise used again and the transport system 2 has to be constructed again when it is required again. In other words, the transport system 2 can be constructed, dismantled, temporarily stored and transported from one site to another site. In this case, the transport system 2 may be composed of individual modules, so different courses of the transport system 2 can be presented at different sites.

In particular in the case of a new build or complete renovation of halls, the rails for the goods, exhibit and service presentation system may alternatively be let into the floor or, alternatively, fastening elements for the rails may be provided. Instead of the rails, magnetic loops, known for example from industrial applications and forming part of the transport system 2, may be laid in the floor. Instead of on or in the floor, the transport system 2 may also be mounted on the hall ceiling and/or an inner wall of the hall, as was described in detail in the above general description.

A plurality of presentation platforms 3, which are arranged spaced apart from one another and moved along the rail of the transport system 2 at a low speed through the hall, are arranged on the transport system 2. The transport system 2 with the presentation platforms 3 is surrounded by at least one stationary area or region 5, in which the visitors can stay while they observe the passing presentation platforms 3, remove goods therefrom or climb thereon in particular when these are trade fair stands manned by people, as outlined in FIG. 1.

Stores are arranged in the interior of the part system 1a in the embodiment. If the presentation platforms 3 are goods shelves, these can repeatedly be filled with new goods from the store region, so the presented goods shelves always appear well filled, which encourages buying.

As the respective turning regions 4 have relatively narrow diameters, the presentation platforms 3 are mounted on turntables (not shown) which rotate the presentation platform 3 when travelling through the turning region 4, so the front 3a of the presentation platform is perpendicularly intersected centrally in each position by a straight line through the centre point of the turning circle.

Access for the visitors into the hall is possible through the normal entrance as the visitor does not have to cross the transport system 2 to arrive at the stationary region 5. Tables and chairs can be set up in the stationary region 5 so the visitor can sit down. Electronic apparatuses may be placed on or integrated in the tables, with which apparatuses the visitor can order goods seen, for example in the case of a market, receive information about the goods on the next shelf that passes the region in which he is staying, or order goods. In the case of an exhibition or an auction, he can for example retrieve information about the exhibits or their prices, etc. at the electronic apparatus. At a trade fair, he can obtain information about the exhibitors via the electronic apparatuses and, for example, establish contact with an interesting exhibitor and arrange a trade fair appointment with him.

In addition, installed in the stationary regions 5 may be wide screens, on which the goods or exhibits presented on the presentation platforms 3, or information about the businesses presented on the trade fair stands, can be shown. In this case, in particular, the information can be shown for the presentation platforms 3, which are just approaching the stationary region 5, from which the screen can be seen.

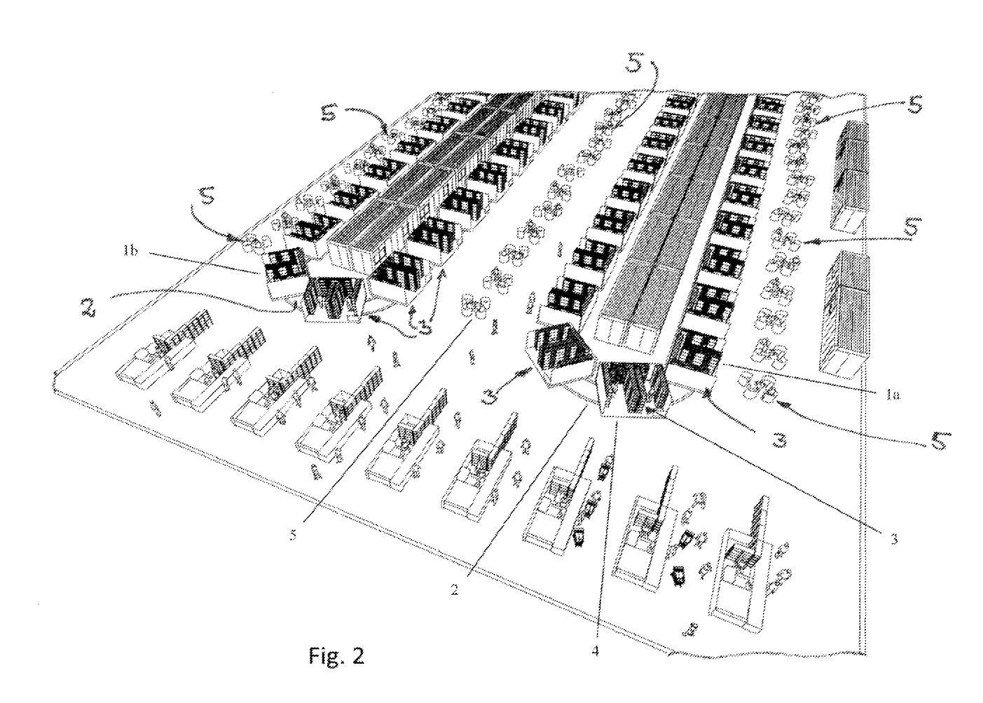

A perspective view of the system 1 of FIG. 1 is shown in FIG. 2.

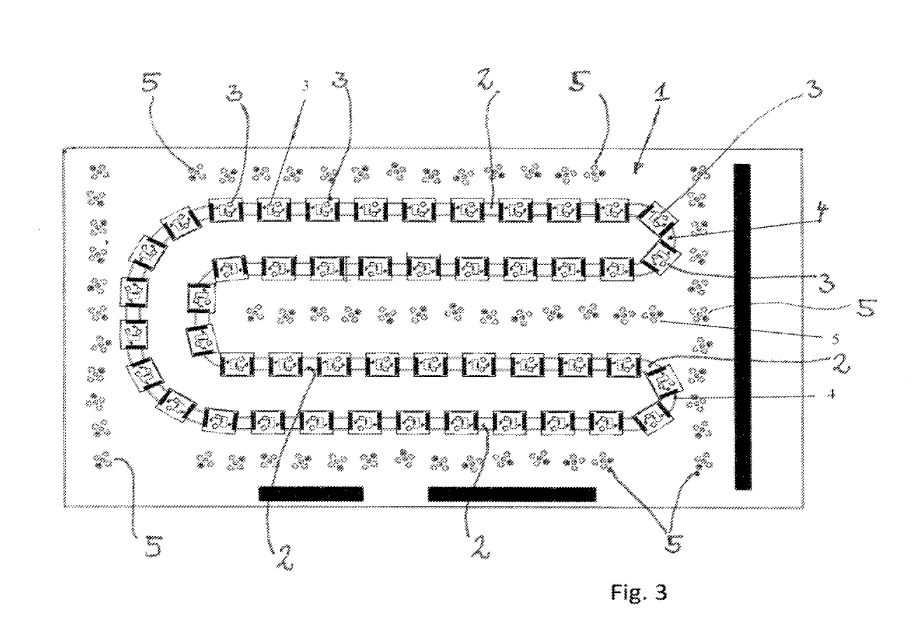

FIG. 3 shows an alternative arrangement of the movable goods, exhibit and service presentation system according to the invention. The transport system 2 with the rails is configured as a closed system 1 as in FIG. 1, but in this embodiment it has a U-shape.

Otherwise, the system of FIG. 2 substantially corresponds to the system 1a, 1b of FIG. 1. In other words, the hall is freely accessible without the visitors having to cross the rails of the transport system 2 to arrive at the stationary region 5.

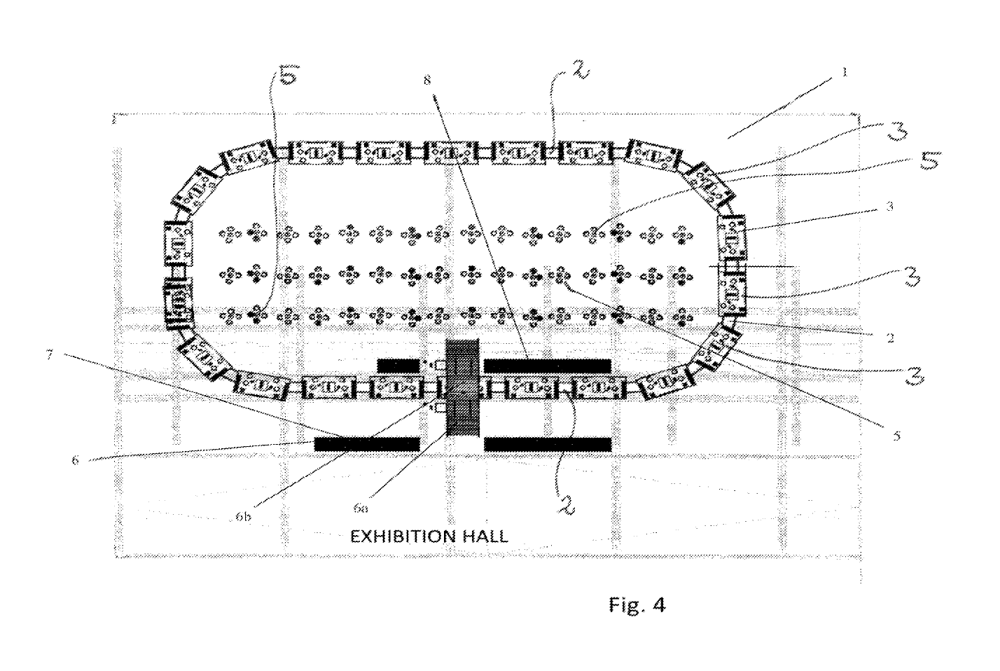

FIG. 4 is a plan view of a further inventive movable goods, exhibit and service presentation system which is installed in a hall. The system 1 is in turn a closed system 1 with a transport system 2 with rails and a large number of presentation platforms 3, which are movably arranged on the rails and can be moved by the transport system 2 along the rails.

In contrast to the systems 1, 1a, 1b shown in FIGS. 1 and 2, the stationary region 5 is arranged in the interior of the transport system 2 forming a closed circle, so the visitors have to cross the rails to reach the stationary region 5. Therefore, the system of FIG. 3 has a bridge 6, which extends over the transport system 2. The bridge 6 has a clearance height, which is higher than a predetermined permissible maximum height of structures on the presentation platforms 3. The bridge 6 can be reached by staircases 6a or by lifts 6b, so even wheelchair users or people with disabilities can easily reach the stationary region 5.

In the embodiment shown, a trade fair hall is shown, with a large number of trade fair stands, which are constructed on the presentation platforms 3. In the example shown, all the presentation platforms 3 have a size of, for example, 4 m by 8 m and a spacing from one another of, for example, 2 m. These dimensions are, however, only examples which do not in any way limit the scope of the invention. Further devices 7, 8 are arranged in the stationary region 5 and outside the system 1. These are, for example, mobile containers, which are deposited in a fixed manner in the hall during the trade fair.

The devices 8 in the stationary region 5 may, for example, be catering stations to be able to supply the visitors in the stationary region 5 with drinks and snacks. The devices 8 may also be information stands manned by staff and/or be electronic information stands. The devices 7 may, for example, be supply and disposal stations, which can supply the trade fair stands with material etc. These may be stationary first aid stations, workshops for trade fair constructors or other necessary supply stations.

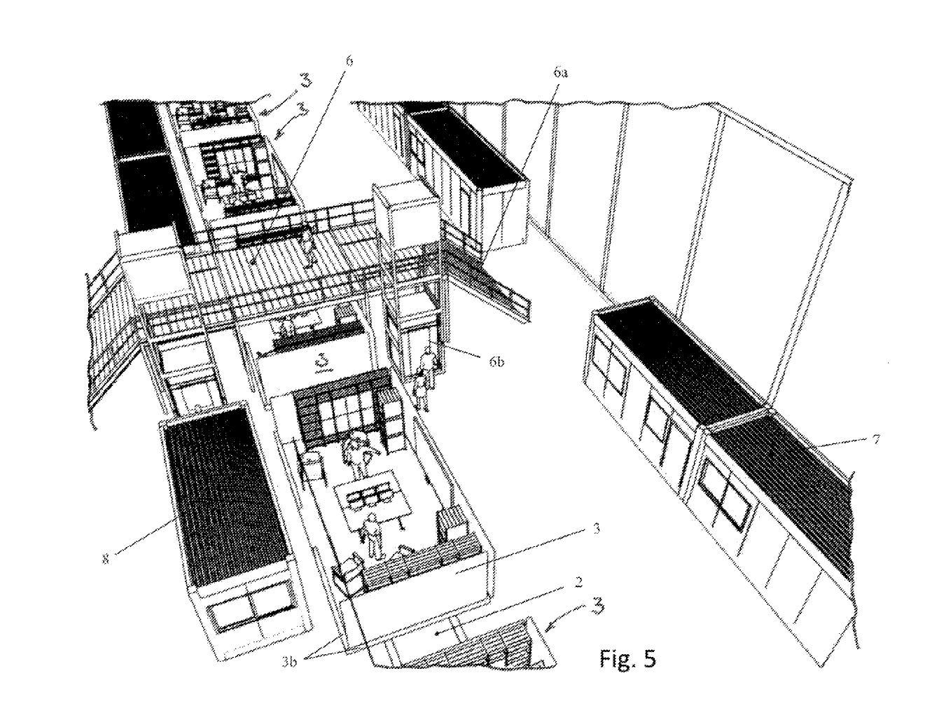

FIG. 5 shows a perspective view into the trade fair hall of FIG. 4. It can be seen that the trade fair stands on the presentation platforms 3 have three substantially closed sides and one open side facing the stationary region 5. Interested visitors who are interested in a consultation or intensive information can climb from the stationary region 5 onto the presentation platform 3 and travel along on the presentation platform 3. In this case, the staff of the trade fair stand can influence the movement speed of the presentation platform 3 by means of a, for example, electronic operating button to allow the visitor to climb on safely. For example, the presentation platform can be stopped when a disabled person or a wheelchair user would like to board. In this case, the stopping of the presentation platform 3 leads to the stoppage of the entire transport system 2.

In the embodiment shown, the back walls of the trade fair stands are also shown as closed walls. These walls are preferably connected to the presentation platform 3 in such a way that in the event of an emergency in the hall, they can easily and rapidly be overturned. As a result, the visitors in the stationary region 5 can reach the hall exits over the bridge 6 and via the presentation platforms 3 and through the free spaces between the presentation platforms 3 so the danger of panic owing to bottlenecks in the escape path is reduced.

The front and the sides of the presentation platforms 3 have claddings 3b projecting to or just above the floor of the stationary region 5 to prevent visitors, in particular when climbing onto the presentation platform 3, from being able to reach with their toes below the presentation platform 3. The presentation platform 3 preferably has a cladding 3b of this type all the way around.

The spacing between two consecutive platforms can be predetermined by the transport system 2 on the rails. If the transport system 2 is a rail-free transport system, sensors can continuously check the spacing of two consecutive presentation platforms 3 and keep it substantially constant via a controller or regulator. The space between the opposing sides of two consecutive presentation platforms 3 may be free, as shown. The space between the opposing sides of two consecutive presentation platforms 3 may, however, also be covered, for example, in the case of conductive rails. The covering (not shown,) has to be designed in such a way here that it can resiliently deform on journeys around curves (bellows principle) or can partially, for example, pivot below the presentation platforms 3. The covering in this case should be stable such that in the event of panic, people can walk over the coverings without the danger of the coverings collapsing under their weight.

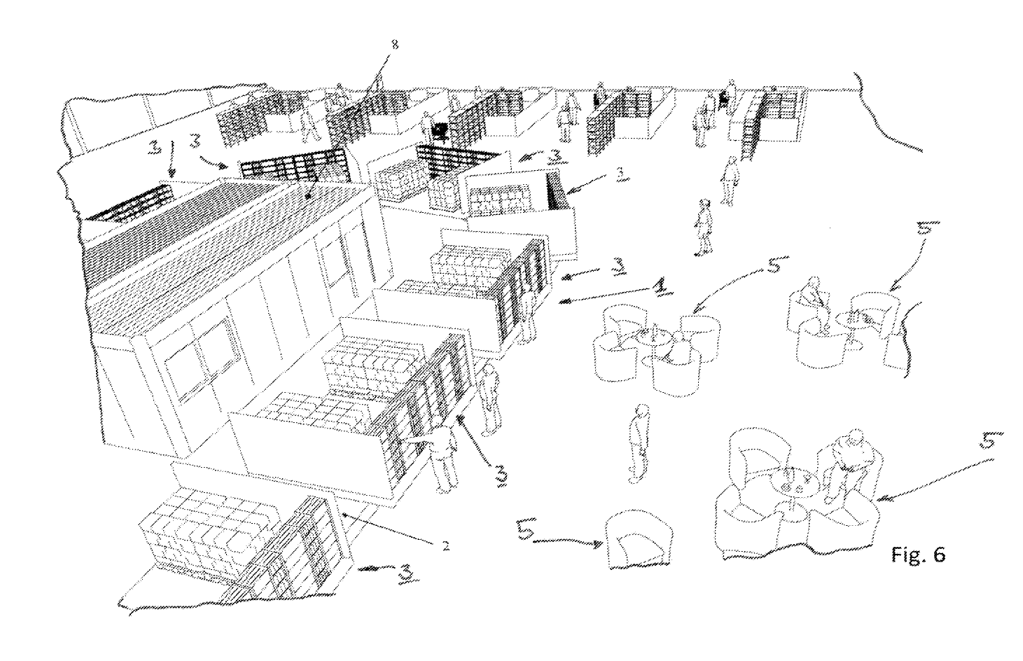

FIG. 6 shows a salesroom for, for example, supermarket goods, books, clothing etc. The salesroom has a region with the system 1, a stationary area or region 5 and a cash desk region with the known conventionally arranged goods shelves. Arranged on the presentation platforms 3 are goods shelves, on which the goods are arranged as in the normal supermarket. The visitor can now remove the desired goods from the shelves and place them in a shopping cart. Together with the shelves, pallets of goods are stored on the presentation platforms 3 so as to be able to rapidly replace the goods removed from the goods shelf. Shop employees can climb onto the presentation platforms from the side remote from the stationary region 5 and replace goods removed from the goods shelves.

The customer can thus comfortably wait at a site such that the entire, or at least the most important part, of the goods selection is moved past him on the presentation platforms 3. For goods and/or promotions that are less often requested, stationary shelves, for example as shown in the cash desk region, may also be present. As the shelves move with the presentation platforms 3 through the transport system 2 along the stationary region 5, numerous customers can remove goods simultaneously or consecutively from the shelves without any jostling occurring.

To indicate to the shop staff that the goods shelf on a presentation platform 3 has to be filled, the shelves may have sensors which indicate to the shop staff, for example on a stationary computer or a mobile apparatus, such as a mobile telephone or similar, that at least one goods item on the goods shelf has fallen below a predetermined minimum piece number. The sensors may be local weight sensors, which detect on the basis of the weight when there are few goods on one position on the goods shelf, or optical sensors, which for every goods item separately record each time the goods shelf is reached into to remove the goods and by simple subtraction of the number of removed goods from the number of the same goods arranged in the goods shelf, establish that a supply of these goods in the goods shelf has fallen below the predetermined minimum piece number. Alternatively, the sensors may also switch on a light signal at the presentation platform when it is necessary to reload at least one goods item.

As already described above, the goods may also be books and other printed articles and/or games, cards, pens/pencils, etc., in other words every type of article to be found, for example, in a DIY store, a garden centre, a health food store, a drugstore, a haberdashery, a perfumery, or any other retail or wholesale business. The scope of the invention is not determined by the trade fair stands, goods or exhibits transported on the presentation platforms 3.

Although the movable goods, exhibit and service presentation system according to the invention has been shown in the drawings exclusively as a system 1 installed in a single hall, it is again explicitly pointed out that this system 1 can advantageously also be installed between the halls in a plurality of halls and/or over a plurality of storeys and/or in the open air. In this case, all the essential elements of the system 1, such as the transport systems 2 with the presentation platforms 3, can be constructed on site, or the system can, in particular in new halls or plants, be at least a partially fixed component of the building or plant. The system 1 may consist of as many subsystems 1a, 1b as desired, which are monitored by a central controller or local subcontrollers for each subsystem 1a, 1b.

What is claimed is:

1. System for presenting one or more of goods, exhibits, or services for customers or visitors, the system comprising:
at least one stationary area (5),
at least one movable transport system (2) having a plurality of presentation platforms (3), together forming a transport device, wherein the plurality of presentation platforms (3) pass the stationary area (5) one after the other,
wherein:
at least one presentation platform (3) is a trade fair stand manned by staff, or
at least one presentation platform (3) is a goods shelf, or
at least one presentation platform (3) carries at least one exhibit.

2. The system according to claim 1, wherein the stationary area (5) is a communication region and the closed spaces are one or more connected halls or a supermarket.

3. The system according to claim 1, wherein the transport system (2) is a continuous transport system, into which the presentation platforms (3) are coupled individually and from which the presentation platforms (3) are decoupled individually.

4. The system according to claim 3, wherein the transport system is circular or at least in a part U-shaped.

5. The system according to claim 1, wherein the transport system (2) is connected to a floor of a space or in an open air.

6. The system according to claim 1, wherein the transport system (2) is driven and moves at least one of the presentation platforms (3) along the transport device.

7. The system according to claim 1, wherein the system (1) comprises at least one belt conveyor, accessible to the customers or visitors, and transports the customers or visitors in and/or counter to the running direction of the transport system (2).

8. The system according to claim 1, wherein the system (1) comprises a service station and/or at least one of the presentation platforms (3) comprises a storage region in/from which consumables or goods are disposed of from the presentation platforms (3) and/or replenished.

9. The system according to claim 1, wherein the system (1) comprises a parking position for at least one presentation platform (3) when the transport system (2) is active.

10. The system according to claim 1, wherein the stationary area (5) has at least one interactive terminal, with which the customers or visitors establish contact with each individual presentation platform (3) and/or order goods from a shelf.

11. The system according to claim 1, wherein a speed of the transport system (2) is regulated externally and/or from a presentation platform (3).

12. The system according to claim 1, wherein the system comprises a safety device for monitoring at least one of a safety region of the stationary device (5) in the immediate surroundings of the presentation platforms (3) or a safety spacing of two directly consecutive presentation platforms (3), and the safety device brings about an emergency shutdown of the transport system (2) when a breach of the safety region is detected.

13. Method for exhibiting or presenting at a trade fair, a public exhibition, a public auction or a sales event, the method comprising:
coupling together a plurality of presentation platforms (3) in the manner of a train; and
moving the coupled presentation platforms at a speed of less than 5 km/h in a continuous loop, on a predetermined transport path, and in a predetermined direction past a stationary region (5) for visitors to the trade fair, the exhibition, the auction or the sales event.

14. The method according to claim 13, wherein a first and a last of the presentation platforms (3) coupled in the manner of a train are coupled to one another, and all the coupled presentation platforms (3) are moved as a closed chain of presentation platforms.

15. Circulating device for exhibition to a large number of distributed observers or interested parties having:
a transport system (2) and a large number of presentation platforms (3), coupled to one another to form a continuous transport device, guided on the transport system (2) and is therefore movable,
the presentation platforms (3) are booths of a trade fair,
wherein the transport system (2) is arranged on a floor and the continuous presentation platforms (3) are movable along the transport system (2), driven by a motor.

16. The system according to claim 15, wherein the transport system (2) is circular or at least in a part U-shaped.

17. The system according to claim 15, wherein the presentation platforms (3) are coupled into the continuous transport device individually and/or are decoupled individually.

18. The system according to claim 15, wherein the plurality of presentation platforms (3) one after the other pass a large number of stationary devices distributed along the transport system (2).

19. The system according to claim 15, wherein a speed of the presentation platforms (3) is regulatable from outside the transport system (2) or from a presentation platform (3).

20. The system according to claim 15, having a central controller to control the longitudinally movable continuous transport device.

21. (canceled)

22. The system of claim 1, wherein the transport system is connected to a ceiling or a wall of a room or a hall.

23. The system of claim 1, wherein at least one presentation platform is driven to move one or more of the plurality of presentation platforms along the transport device.

24. The system according to claim 2, wherein the communication region is provided with at least one personnel.

25. The system according to claim 9, wherein the at least one presentation platform comprises the trade fair stand.

26. The system according claim 11, wherein the system comprises a central controller for controlling at least one of the system or the at least one platform.

27. The system according to claim 12, wherein the safety device comprises optical sensors for monitoring the at least one of the safety region of the safety spacing.
